(19) United States
(12) Patent Application Publication
(10) Pub. No.: US 2005/0035079 A1
(43) Pub. Date: Feb. 17, 2005

(54) Beverage containers with nubs and method for producing such beverage containers

(75) Inventors: Fredric Edelstein, Philadelphia, PA (US); Jack K. Y. Li, Hong Kong (HK)

Correspondence Address: COOK, ALEX, MCFARRON, MANZO, CUMMINGS & MEHLER LTD, SUITE 2850, 200 WEST ADAMS STREET, CHICAGO, IL, 60606, US

(73) Assignee: CDI International, Inc. and Lister Enterprise (H.K.) Ltd.

(21) Appl. No.: 10/641,228

(22) Filed: Aug. 14, 2003

(51) Int. Cl. A47J 41/00

(52) U.S. Cl. 215/13.1

(57) ABSTRACT

The present invention is directed to a beverage container with nubs and a method for producing such beverage containers with nubs.

### FIELD OF THE INVENTION

The present invention is directed to a method for producing beverage containers having nubs and beverage containers with nubs.

### BACKGROUND OF THE INVENTION

Many beverage containers, such as travel mugs, today have a stainless steel or similar type metal exterior. Such metal exteriors, however, can be slippery. Further, such containers can reflect the surrounding environment. For example, if it is a hot day or if the mug is left in a hot car, the metal exterior of the mug can be hot to touch. Likewise, if it is a cold day, the mug can be cold to touch.

Accordingly, it is desirable to have some type of material on the exterior of the mug or extending from the outside of the mug so that the user can securely hold onto the mug, but do so without being subjected to extreme heat or cold. Therefore, it is an object of the present invention to provide a container or mug with nubs, which extend through holes in the metal exterior to provide a surface for the user to grasp when holding the mug without having to directly hold the metal or plastic exterior of the mug and a method for producing such containers.

### SUMMARY OF THE INVENTION

The present invention is directed to a beverage container with nubs and a method for producing such beverage containers with nubs. More specifically, the present invention is directed to beverage containers having an exterior shell with apertures or holes in the shell, a liner inside of the shell, and strips with nubs thereon. The strips are located between the liner and the shell with the nubs sticking out of the apertures in the shell.

In a further embodiment of the present invention, a support layer is located between the strips and the liner. The support layer provides the necessary support so that the nubs cannot be pushed back into apertures in the container. Preferably, the support layer is made of metal, plastic or hard rubber. Additionally, a layer of insulation can be provided between the support layer and the liner.

In a further embodiment, the nubs and strips are rubber, plastic or some combination thereof. Further, the exterior shell and/or the liner can be metal or plastic. The present invention is also directed to a method for producing a beverage container with nubs by forming an interior liner, forming an exterior shell with apertures therein, wherein the liner fits within said exterior layer; and forming strips with nubs thereon. In the method, the strips are located between the exterior shell and the interior liner, and the nubs are pushed through the apertures in the exterior shell.

### BRIEF DESCRIPTION OF THE DRAWINGS

FIG. 1 illustrates an example of a beverage container or mug according to one embodiment of the present invention.

FIG. 2 is a cut away view showing a portion of the container of FIG. 1 along line A-A¹.

FIG. 3 shows the container of FIG. 1 with a cap.

FIG. 4 is a side view of a cap for use with the container of the present invention.

### DETAILED DESCRIPTION OF THE PRESENTLY PREFERRED EMBODIMENTS

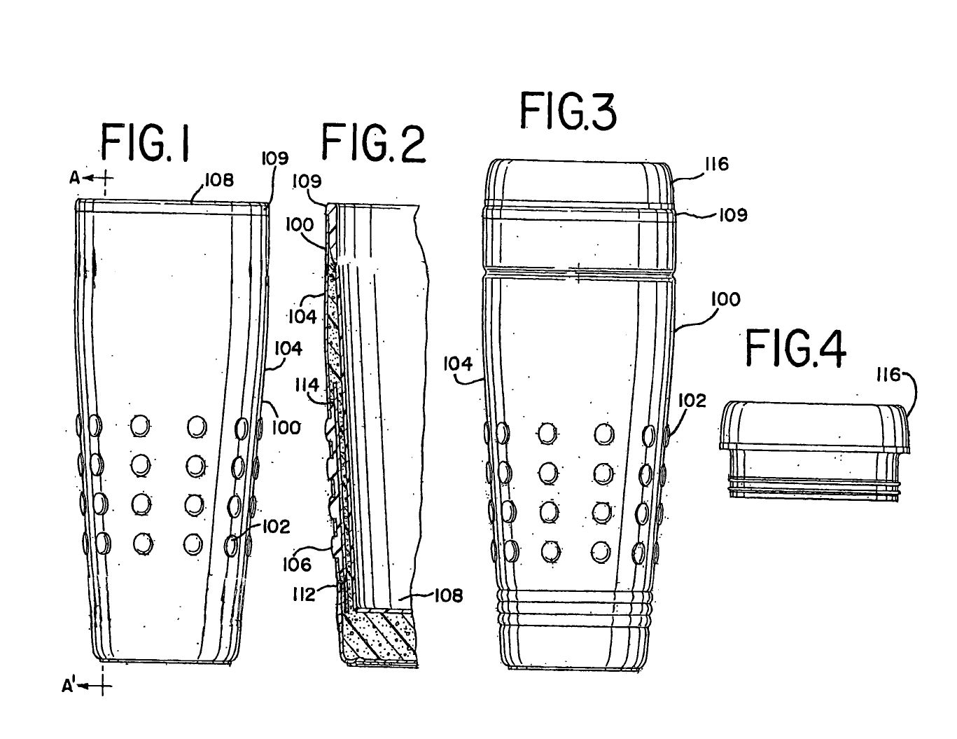

FIG. 1 illustrates an example of a beverage container 100 of one embodiment of the present invention. FIG. 2 is a cut away view showing the container of FIG. 1. FIG. 3 shows a container with an optional cap and exterior design details.

Container 100 in FIG. 1 has nubs 102 which protrude from the side of the container. As explained supra, these nubs are helpful in providing a surface for the user to grab and hold onto when using the container.

FIG. 2 shows, in a cut-away view, a portion of container 100 along line A-A¹ in FIG. 1. As shown in FIGS. 1 and 2, container 100 has an exterior shell 104 with holes 106 therein. The holes can be of any shape or size. Shell 104 can be made of for example, metal or plastic. Examples of materials that can be used for the shell include stainless steel, polypropylene and acrylic The shell can be formed using methods well known in the art. Holes 106 in shell 104 can be stamped out if the shell is made of metal or formed as part of the tooling for polypropylene or acrylic shells. Exterior shell 104 can be in whatever shape that is desired for the container. For example, the container and shell can be cylindrical. They could also be long or short, narrow or wide, the same width throughout or wide at the top or bottom. Other shapes are also contemplated, as the present invention is not intended to be limited to any particular shape. The shell may also have design details thereon such as grooves or etchings, or have printed material thereon.

Preferably, a plastic or metal liner 108 is located inside shell 104. Liner 108 is typically where the beverage will be placed and where the beverage will be in contact with container 100. In one possible embodiment, liner 108 can have a lip 109 at the top of the liner which extends over the top of shell 104 so that the lip 109 of liner 108 will rest on shell 104. The present invention, however, is not limited to a particular shape of the liner or to having a lip on the top of the liner, as the liner can be held within the shell by other means known in the art. For example, the liner and shell of the container can be held together by sonic welding. Alternatively, a gasket, glue or a screw at the bottom of the container can be used to hold the liner and shell together.

Between liner 108 and shell 104 is preferably (from inside of the container to outside) a layer of insulation 110, a support layer 112, and strips 114. The layer of insulation 110 can be made of a foam, such as for example, polystryrene or other well known insulating foams or materials. Insulation 110 is intended to keep the container insulated, i.e. to keep the beverage within the container hot or cold as desired. Such an insulation layer, however, is optional and not necessary for the present invention. Strips 114 have nubs 102 thereon. Preferably, nubs 102 and strips 114 are made of rubber. The nubs 102 on the strips 114 poke through holes 106 in shell 104 so that the nubs 102 extend beyond the exterior of shell 104 and form a gripping surface on the outside of the container. Preferably, the nubs and strips are a one-piece structure. The strips 114 and nubs 102 could also be made of other materials, such as for example, plastic or some combination thereof, e.g. plastic strips and rubber nubs or vice versa. The nubs and strips could also be made separately, and the nubs attached to the strips. The support layer 112 is intended to provide support for strips 114 so that nubs 102 will continue to extend through holes 106 and will not be pushed back into the container. Preferably, layer 112 is made of metal. Layer 112 could be made of other materials, such as for example, plastic or stiff rubber. Preferably, support layer 112 extends around the container. Lengthwise, support layer 112 can be merely as long as strips 114, or extend slightly beyond the strips as shown in FIG. 2, or extend the full length of the container.

A cap 116, such as that shown in FIGS. 3 and 4 can be placed on container 100 but is not necessary for the present invention. Other caps or covers are also contemplated in the present invention. The cap for example can be screwed on the container or pushed on with rubber gaskets located at the bottom of the cap to form a tight seal with the container.

The present invention is also directed to a method of making such a container having the steps of forming an interior liner 108, forming an exterior layer 104 with apertures 106 therein, wherein the liner 108 fits within the exterior layer 104, forming strips 114 with nubs 112 thereon, and forming a support layer 112. The strips 114 and support layer 112 are located between the exterior layer 104 and the interior liner 108, and the support layer 112 is located between the strips 114 and the liner 108. The nubs 102 are pushed through the apertures 106 in the exterior layer 104.

The present invention may be used to produce mugs, such as for example travel mugs, cups, tumblers, and other beverage ware. The nubs can be located on the side of the container, or elsewhere on the container, such as for example in a handle on the container. For example, if the nubs are located on the handle or other location of the beverage container where the liner is not present, the present invention will include an exterior layer with apertures therein, strips with nubs thereon, and a support layer. The strips are located between the exterior layer and the support layer, and the nubs are pushed through the apertures in the exterior layer. The details of such layers are the same as those described supra for the other embodiments. This embodiment can be produced by a method including the steps of forming an exterior layer with apertures therein, forming strips with nubs thereon and forming a support layer. The strips are located between the exterior layer and the support layer. The nubs are pushed through the apertures in the exterior layer.

It will be understood that the embodiments and examples of the present invention, which have been described, are illustrative of some of the applications of the principles of the present invention. Numerous modifications may be made by those skilled in the art without departing from the spirit and scope of the invention.

1. A method for producing a beverage container with nubs comprising:
forming an interior liner;
forming an exterior shell with apertures therein, wherein said liner fits within said exterior layer; and
forming strips with nubs thereon and a support layer,
wherein said strips and support layer are located between said exterior shell and said interior liner with said support layer being between said strips and said liner and wherein said nubs are pushed through said apertures in said exterior shell.

2. The method of claim 1 wherein said support layer is made of metal.

3. The method of claim 1 wherein said support layer is made of plastic.

4. The method of claim 1 further comprising providing a layer of insulation between said support layer and said liner.

5. The method of claim 1 wherein said strips are formed of rubber.

6. The method of claim 1 wherein said nubs are formed of rubber.

7. The method of claim 1 wherein said strips are formed of plastic.

8. The method of claim 1 wherein said nubs are formed of plastic.

9. A method for forming a beverage container comprising:
forming an exterior layer with apertures therein;
forming strips with nubs thereon; and
forming a support layer,
wherein said strips are located between said exterior layer and said support layer, and said nubs are pushed through said apertures in said exterior layer.

10. The method of claim 9 wherein said exterior layer is located on a handle for said container.

11. The method of claim 9 wherein said exterior layer forms an exterior shell for the container.

12. A beverage container comprising:
an exterior shell with apertures therein;
a liner inside said shell;
a support layer between said shell and said liner; and
nubs located on strips, said strips being located between said shell and said support layer,
wherein said nubs are in said apertures and extend through said shell and said support layer provides support for said strips and said nubs.

13. The container of claim 12 wherein said support layer is made of metal.

14. The container of claim 12 wherein said support layer is made of plastic.

15. The container of claim 12 further comprising providing a layer of insulation between said support layer and said liner.

16. The container of claim 12 wherein said strips are formed of rubber.

17. The container of claim 12 wherein said nubs are formed of rubber.

18. The container of claim 12 wherein said strips are formed of plastic.

19. The container of claim 12 wherein said nubs are formed of plastic.

20. A beverage container comprising:
an exterior layer with apertures therein;
strips with nubs thereon; and
a support layer,
wherein said strips are located between said exterior layer and said support layer, and said nubs are pushed through said apertures in said exterior layer.

21. The method of claim 20 wherein said exterior layer is located on a handle for said container.

22. The method of claim 20 wherein said exterior layer forms an exterior shell for the container.
